(19) United States
(12) Patent Application Publication
(10) Pub. No.: US 2002/0075914 A1
(43) Pub. Date: Jun. 20, 2002

(54) Semiconductor laser module, laser unit, and raman amplifier

(75) Inventor: Satoshi Koyanagi, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: THE FURUKAWA ELECTRIC CO., LTD., Tokyo (JP)

(21) Appl. No.: 09/984,091

(22) Filed: Oct. 26, 2001

(30) Foreign Application Priority Data
Nov. 2, 2000 (JP) 2000-336492

(51) Int. Cl. H01S 3/10; H01S 3/04; H01S 3/08

(52) U.S. Cl. 372/36; 372/20; 372/108

(57) ABSTRACT

The present invention provides a semiconductor laser module emitting a laser beam from a resonance section having a semiconductor laser device and a diffraction grating therein, and the semiconductor laser device is set in the multimode oscillation state, and by controlling a reflectivity spectrum form or a reflectivity of the diffraction grating, a laser beam spectrum emitted from the resonance section is arranged so that a plurality of longitudinal modes may be included within −3 dB from an optical amplitude of a main peak as a reference in a prespecified wavelength band widths including the main peak.

### FIELD OF THE INVENTION

The present invention relates to a semiconductor laser module for emitting a laser beam, a laser unit using the semiconductor laser module, and a Raman amplifier using the semiconductor laser module or the laser unit.

### BACKGROUND OF THE INVENTION

Conventionally, as a signal light beam source module for optical communications or an excited light beam source module for an optical amplifier, there has widely been used a semiconductor laser module for transmitting a laser beam generated by a semiconductor laser device in an optical fiber.

Further to select and stabilize an oscillation wavelength of a semiconductor laser device, there has widely been used also the technology of providing a wavelength selection means such as a diffraction grating for returning a laser beam emitted from a semiconductor laser device to the semiconductor laser device itself.

For instance, Japanese Patent Laid-Open Publication No. HEI 9-246645 or No. HEI 9-283847 discloses a semiconductor laser module having a wavelength selection means in which a reflectivity spectrum width of a diffraction grating functioning as a wavelength selection means is set to a value larger than a wavelength space of a laser beam resonating between two facets of a semiconductor laser device in its longitudinal mode.

In this case, by setting a reflectivity spectrum width of a diffraction grating to a large value, generation of kinking in the current-light (I-L) characteristics of a laser beam can be prevented, and further the optical power can be stabilized.

The reflectivity spectrum form in the FBG (fiber Bragg gratings) widely used as a diffraction grating or in the dielectric multilayered film is in most cases a convex one with a substantially sharp tip. Because of this form, also a spectrum of a laser beam emitted from a semiconductor laser module is often in the state where only one longitudinal mode as a main peak has a high optical amplitude. In industrial applications, also a laser beam having the spectrum as described above is often required.

In the conventional type of a semiconductor laser module which outputs a laser beam with only one longitudinal mode at a high level, it is possible to realize an excited light beam with a high laser power or to reduce a loss in a WDM (wavelength division multiplexing) coupler used for wavelength synthesis, which are characteristics required when the semiconductor laser module is used in a Raman amplifier. However, in the semiconductor laser module having the characteristics as described above, it has been impossible to suppress SBS (simulated Brillouin scattering) or to reduce DOP (degree of polarization).

### SUMAMRY OF THE INVENTION

It is an object of the present invention to provide a semiconductor laser module capable of concurrently satisfying all of the requirements of realization of an excited light beam with high optical power, small loss in a WDM coupler in wavelength synthesis, suppression of SBS, and reduction of DOP, a laser unit using the semiconductor module, and a Raman amplifier using the semiconductor module or the laser unit.

To achieve the object described above, the present invention provides a semiconductor laser module comprising: a semiconductor laser device; a wavelength selection means for deciding an oscillation wavelength of the semiconductor laser device; and an optical fiber for transmitting a laser beam emitted from a resonance section having the semiconductor laser device and the wavelength selection means, wherein the semiconductor laser device oscillates in the multimode, and a plurality of longitudinal modes are included within −3 dB from an optical amplitude of a main peak in a spectrum of the laser beam emitted from the resonance section.

The present invention provides also a laser unit comprising: a plurality of the semiconductor laser modules as described above; and a plurality of depolarizers which reduce DOP's of laser beams emitted from the plurality of semiconductor laser modules respectively.

The present invention provides also a laser unit comprising: a plurality of the semiconductor laser modules as described above; and a plurality of polarization synthesis means for subjecting laser beams emitted from the plurality of semiconductor laser modules to polarization synthesis.

The present invention provides also a Raman amplifier comprising: the semiconductor laser module as described above or the laser unit as described above; and a control means for controlling the semiconductor laser module or the laser unit.

### BRIEF DESCRIPTION OF THE DRAWINGS

FIG. 1 is a general block diagram showing a structure of a semiconductor laser module according to a first embodiment of the present invention;

FIG. 2 is a view showing an oscillation spectrum of an output light beam from the semiconductor laser module shown in FIG. 1;

FIG. 3 is an enlarged view showing a form of a tip of the oscillation spectrum shown in FIG. 2, and is a waveform diagram showing a case where there are two longitudinal mode peaks;

FIG. 4 is a view showing the output characteristics of the semiconductor laser module shown in FIG. 1;

FIG. 5 is an enlarged view showing a form of a tip of the oscillation spectrum shown in FIG. 2, and is a waveform diagram showing a case where there are four longitudinal mode peaks;

FIG. 6 is a waveform diagram showing a reflectivity spectrum of a diffraction grating in the semiconductor laser module shown in FIG. 1:

FIG. 7 is a waveform diagram showing a reflectivity spectrum of a diffraction grating with the tip form controlled;

FIG. 8 is a general block diagram showing a configuration of a Raman amplifier according to a second embodiment of the present invention; and

FIG. 9 is a general block diagram showing a configuration of a Raman amplifier according to a third embodiment of the present invention.

### DETAILED DESCRIPTION OF THE EMBODIMENTS

In recent years, in association with increase of transmission channels for the WDM transmission system, hot attentions have been paid to a Raman amplifier which can obtain a gain in a wide band area. A semiconductor laser module used in this Raman amplifier is required to have the following characteristics.

(1) Realization of an Excited Light Beam with High Optical Power

As a Raman amplifier has generally a low gain, it is necessary to excite it with a laser beam with a high optical power. As an example, at present a semiconductor laser module capable of achieving a high optical power output of 300 mW or more is required.

(2) Small Loss in the WDM Couple During Wavelength Synthesis

In a Raman amplifier, excited light beams from a plurality of channels are synthesized with a WDM coupler and the synthesized light beam is introduced into a transmission path for a signal beam. A wavelength band width of an excited light beam for one channel which can be synthesized with the WDM coupler is very narrow, namely about 2 nm, and therefore when a light beam with a wide band width is introduced into the WDM coupler, light beam outside the wavelength band width of about 2 nm is lost.

To reduce this loss as much as possible, the PIB (power in band) indicating a ratio of an optical amplitude within the wavelength band width actually assigned to one channel in the WDM couple against the general optical amplitude of one channel for an excited light beam introduced into the WDM coupler should preferably be 90% or more.

(3) Suppression of SBS

When a light beam with a high optical amplitude is introduced into an optical fiber to satisfy the requirement (1) above, the optical amplitude of the SBS light beam in the optical fiber becomes larger, which causes increase of noises in the signal light beam. Therefore, it is necessary to suppress generation of this SBS. However, in the conventional type of semiconductor laser modules, the longitudinal mode constituting a main peak has a high optical amplitude, it is difficult to suppress generation of the SBS corresponding to the high optical amplitude of the peak.

(4) Reduction of DOP

In a Raman amplifier, an excited light beam with low DOP is required to reduce influence of the dependency of Raman gain on polarization. As one of the techniques to obtain an optical output with low DOP, there is the technique of depolarization. For depolarization, when a laser beam is introduced into a PMF (polarization maintaining fiber) with a prespecified length, the beam is introduced into and passed through the fiber in the state where a polarization plane of the laser beam is rotated by 45 degrees against the axis of the PMF. In the conventional type of semiconductor laser modules, however, for instance, a long PMF with the length of about 30 m is sometimes required.

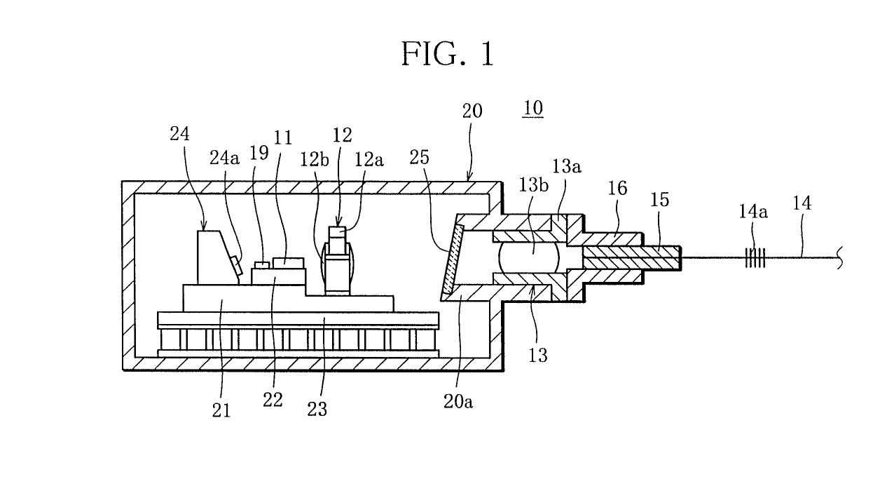

A semiconductor laser module, a laser unit, and a Raman amplifier each according to the present invention are described in detail below with reference to FIG. 1 to FIG. 9.

(First Embodiment)

As shown in FIG. 1, a semiconductor laser module 10 according to this embodiment comprises a semiconductor laser device 11, a first lens section 12, a second lens section 13, an air-tight casing 20 for accommodating therein the first lens section 12 and second lens section 13, and an optical fiber 14 attached to outside of the air-tight casing 20. The semiconductor laser device 11 is optically connected to the optical fiber 14 via a lens system comprising the first lens section 12 and second lens section 13.

The semiconductor laser device 11 has an active area for generating and amplifying a laser beam, a rear facet for reflecting the light beam, and a front facet for partially reflecting the light beam and also transmitting the light beam therefrom. The rear facet and the front facet face each other with the active area between. This semiconductor laser device 11 is provided via a chip carrier 22 on a base 21. Also a thermister 19 for detecting a temperature of the semiconductor laser device 11 is provided on this chip carrier 22.

The base 21 is provided above a Peltier module 23 for controlling a temperature of the semiconductor laser device 11 provided in the air-tight casing 20. This Peltier module 23 absorbs or emits heat so that the temperature detected by the thermister 19 is kept at a constant level. The base 21 and chip carrier 22 are made of material with excellent thermal conductivity, and effectively assists the temperature control of the semiconductor laser device 11 by absorbing or emitting hear with the Peltier module 23.

Further, on the base 21, a carrier 24 is fixed to the side opposite to the first lens section 12 with the chip carrier 22 therebetween. A photodiode 24a for monitoring is provided at a position opposite to the semiconductor laser device 11 on this carrier 24.

The first lens section 12 has a configuration in which a collimetor lens 12b is supported on a lens holder 12a. This lens holder 12a is welded and fixed to the base 21. For instance, an aspheric lens is used as the collimator lens 12b to obtain a high combination efficiency, and the laser beam emitted from the semiconductor laser device 11 is converted to a parallel light beam thereby.

The second lens section 13 has the configuration in which a spheric lens 13b is supported on a lens holder 13a. The lens holder 13a is positionally adjusted on a plane vertical to the light axis and fixed to an insertion cylinder 20a of the air-tight casing 20 described hereinafter. The spheric lens 13b has a cylindrical shape, and converges the parallel light beams from the collimator lens 12b.

The insertion cylinder 20a protruding inward and outward is provided on one side wall of the air-tight casing 20. Attached on the inner face of this insertion cylinder 20a is a hermetic glass plate 25 with a reflection-preventive coating on the surface inclined by a prespecified angle against the axis of the cylinder to seal the air-tight casing 20 in the air-tight state.

The optical fiber 14 is, for instance, a PMF, and its tip side is adhered to inside of a ferrule 15 for protection. This ferrule 15 is adjusted to the optimal position by being slid along the light axis of the optical fiber 14 inside an external sleeve 16 of the insertion cylinder 20a or by being rotated about the light axis, and then is welded and fixed to the sleeve 16.

The lens holder 13a and sleeve 16 are positionally adjusted on a plane vertical to the light axis of the optical fiber 14, and then is welded and fixed thereto respectively.

The optical fiber 14 has a diffraction grating 14a comprising FBG reflecting a light beam with a particular wavelength into a core thereof. This diffraction grating 14a is one example of a wavelength selection means, and forms a resonance section together with the semiconductor laser device 11.

Next, operations of the semiconductor laser module 10 shown in FIG. 1 are described below.

In the semiconductor laser module 10 shown in FIG. 1, the semiconductor laser device 11 generates a light beam when an electric current is flown into the active area thereof, and amplifies the light beam. This light beam is reflected on the rear facet of the semiconductor laser device 11, and is emitted as a laser beam from the front facet.

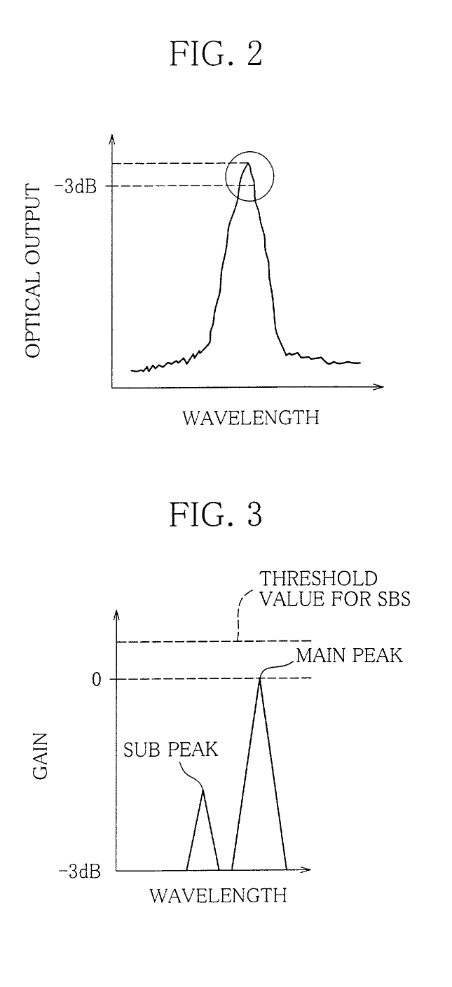

This light beam passes through the collimator lens 12b of the first lens section 12 to be converted to a parallel light beam, and is converged by the spheric lens 13b of the second lens section 13, and then is introduced into the optical fiber 14 at an optimal angle. Then a spectrum of an optical output having the longitudinal modes, for instance, as shown in FIG. 2 is obtained by resonance of the resonance section formed with the semiconductor laser device 11 and the diffraction grating 14a as a wavelength selection means.

By the way, the SBS occurs in the optical fiber 14 of the semiconductor laser module 10 conceivably because only a peak of one longitudinal mode becomes higher in a spectrum of an output light beam. To prevent this phenomenon, in this embodiment, the semiconductor laser device 11 is designed so that it oscillates in the multiple modes. At the same time, as described in detail hereinafter, a spectrum of an output laser beam from the resonance section comprising the semiconductor laser device 11 and diffraction grating 14a is arranged so that a plurality of longitudinal modes may be included within −3 dB from an optical amplitude of a main peak as a reference in a prespecified wavelength band width including the main peak, when a reflectivity spectrum form or a reflectivity of the diffraction grating 14a are controlled appropriately.

It is to be noted that the main peak as defined herein indicates a longitudinal mode having the highest optical amplitude of all the longitudinal modes, and other longitudinal modes are called as sub peak.

Now in the output light beam spectrum shown in FIG. 2, when a tip form within −3 dB from the main peak as a reference surrounded by a circle in the figure is enlarged, it looks as shown in FIG. 3. This figure shows the state where there are two longitudinal mode peaks.

In the case of these two longitudinal modes, when an optical amplitude of the sub peak is made larger, even if an optical amplitude of the main peak is made lower, the total amplitude of the laser beam emitted from the semiconductor laser module 10 can be set to the same value when only one longitudinal mode is extremely high as compared to other peaks. In this case, it is possible to realize a high optical power output of, for instance, 300 mW or more, and the high optical power output can be maintained.

Also when an optical amplitude of the main peak is suppressed to a low value so that it will not surpass a threshold value for occurrence of the SBS, the optical amplitude of all longitudinal modes does not surpass the threshold value for occurrence of the SBS, so that occurrence of the SBS can be suppressed almost completely.

To further suppress a frequency of occurrence of the SBS, as shown, for instance, in FIG. 5, it is preferable to arrange an output laser beam from a resonance section comprising the semiconductor laser device 11 and diffraction grating 14a so that 4 or more longitudinal modes may be included within −3 dB from the optical amplitude of a main peak as a reference in a prespecified wavelength band including the main peak. The number of longitudinal modes included within −3dB from the main peak optical amplitude may be, for instance, from 4 to 6.

In a case where the semiconductor laser module 10 according to the embodiment as described above is used as an excited light beam source module for a Raman amplifier, by arranging an optical amplitude of the main peak to a value lower than that when there is only one longitudinal mode so that optical amplitude of every longitudinal mode will not surpass the threshold value for occurrence of the SBS, it is possible to almost completely suppress occurrence of the SBS in the Raman amplifier.

Even if an optical amplitude of the longitudinal mode changes from time to time in association with reduction of an optical amplitude of the main peak, as four or more longitudinal modes are stably included within −3 dB from an optical amplitude at a peak wavelength in the spectrum, the SBS phenomenon can be suppressed to a practically ignorable level.

However, it is necessary to make the PIB larger when subjecting an output light beam from the semiconductor laser module 10 to wavelength synthesis with a WDM coupler. From this point of view, and also taking into considerations the fact that a wavelength band width of the output light beam is limited to about 2 nm, infinitely increasing the number of longitudinal modes within −3 dB from an optical amplitude of a main peak as a reference is not desirable.

For, the number of longitudinal modes contributing to one SBS phenomenon is by its nature not limited to one, and for instance, all of the longitudinal modes within a prespecified narrow wavelength band width spaced from each other with a plurality of dashed lines respectively shown in FIG. 5 contribute to the SBS phenomenon. The wavelength band width contributing to one SBS phenomenon is herein described as SBS contributing band width. Therefore, when a space between adjoining longitudinal modes is narrowed and a number of longitudinal modes are included in the SBS contributing band width, a sum of optical amplitudes of many longitudinal modes contributes to one SBS phenomenon. As a result, the optical amplitude surpasses the threshold value for occurrence of the SBS, which disadvantageously causes the SBS phenomenon.

From this point of view, it is advantageous to set a space between longitudinal modes in a spectrum of a laser beam emitted from the semiconductor laser module 10 according to the present embodiment to a value larger than the SBS contributing band width, namely, for instance, about 0.1 nm or more.

The DOP is described below. In the semiconductor laser module 10 according to the present embodiment, it is possible to increase a number of longitudinal modes included within −3 dB from an optical amplitude of a main peak as a reference in a prespecified wavelength band width including the main peak, a coherent length of an output light beam can be made shorter. Therefore, a length of the PMF required for depolarization for reduction of THE DOP can be made shorter.

For instance, in a spectrum of an output light beam, when only one longitudinal mode is included within −3 dB from an optical amplitude of the main peak as a reference, it is required for reducing the DOP to 10% of the original level that the length of the PMF is a little less than 30 m. When there are four longitudinal modes within −3 dB from an optical amplitude of the main peak as a reference, the length of the PMF is required to be only less than 10 m.

Further a wavelength band width of a laser beam emitted from the semiconductor laser module 10 is fully suppressed by returning the laser beam to the semiconductor laser device 11 with the diffraction grating 14a, and therefore the requirement that PIB is more than 90% in a wavelength band width of 2 nm can fully be satisfied.

A laser beam with a narrow wavelength band width and few changes in the wavelength is required as a laser beam emitted from an excited light beam source module for a Raman amplifier. In the semiconductor laser module 10 according to the present embodiment, a spectrum width of an output light beam can be compressed and a wavelength can be stabilized by returning a light beam with a prespecified wavelength from the diffraction grating 14a to the semiconductor laser device 11. Therefore, this semiconductor laser module 10 is very advantageous as an excited light beam source module for a Raman amplifier.

Generally it is not so easy to control a spectrum form or an optical amplitude of a main peak of a laser beam emitted from a semiconductor laser module only by designing a semiconductor laser device. In the semiconductor laser module 10 according to the present embodiment, however, it is possible to control a spectrum form or an optical amplitude of a laser beam emitted from the semiconductor laser module 10 to some extent by controlling a reflectivity spectrum form or a reflectivity of the diffraction grating 14a. Operations for setting a reflectivity spectrum of the diffraction grating 14a are described below.

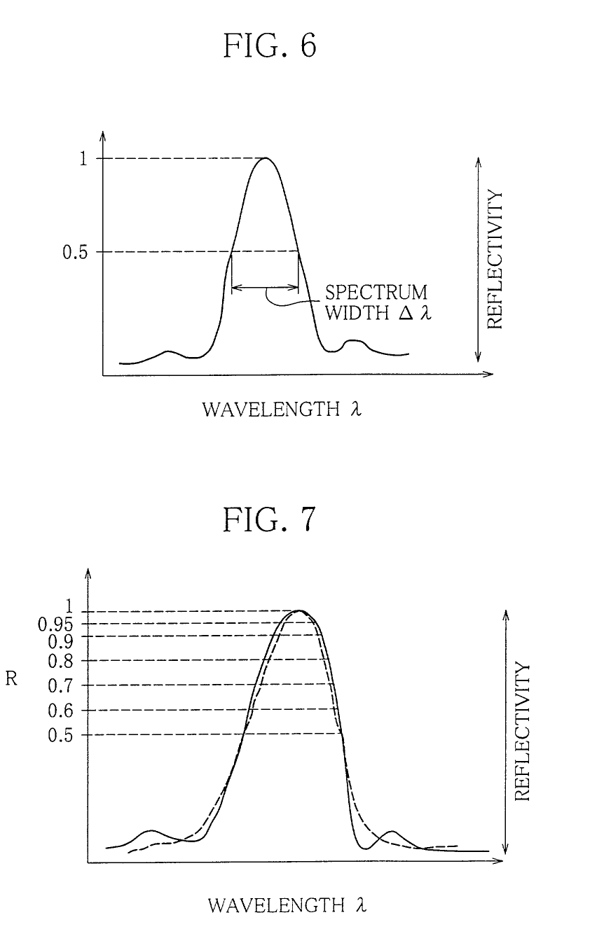

When the semiconductor laser module 10 is used as an excited light beam source module for a Raman amplifier, wavelength synthesis is performed by a WDM coupler. For reducing a loss in this WDM coupler to realize the PIB of 90% or more, a wavelength band width (herein, full width at half maximum) Δλ of a laser beam emitted from the semiconductor laser module 10 should preferably be in the range from 0.3 to 3 nm, and more preferably in the range from 0.5 to 2 nm. To satisfy this requirement, a reflectivity spectrum width (herein, full width at half maximum) Δλ of the diffraction grating 14a as shown in FIG. 6 should preferably be in the range from 1 to 4 nm, and more preferably be in the range from 1.5 to 2 nm.

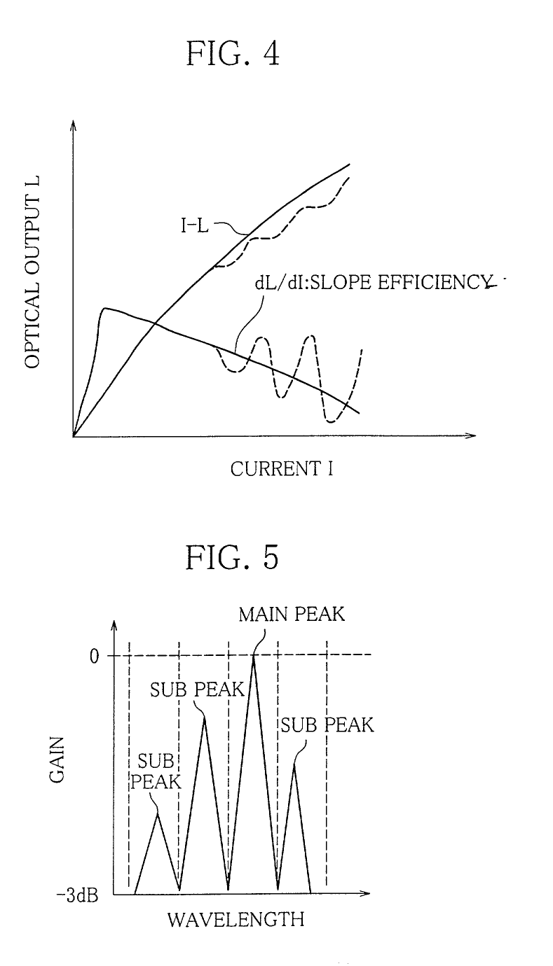

The current-optical output characteristics in a case where a plurality of Fabry-Perot modes are included in a reflectivity spectrum width of the diffraction grating 14a is as shown in FIG. 4. In FIG. 4 the current-optical output characteristics in the conventional technology is indicated by a dashed line for comparison.

As clearly shown in FIG. 4, in the conventional technology, kinking is generated in the current-optical output characteristics, and the slope efficiency dL/dI which is a slope of the I-L curve largely fluctuates. In contrast, in this embodiment, generation of kinking in the current-optical output characteristics and substantial fluctuation of the slope efficiency dL/dI can be prevented. To achieve the objective, a cavity length of the semiconductor laser device 11 should preferably be in the range from 800 to 3200 μm.

A very high optical output is required to a excited light beam source module for a Raman amplifier. Therefore, a lower reflectivity of the diffraction grating 14a is better, because, in the case, a transmission loss is smaller. In addition, also a front facet reflectivity of the semiconductor laser device 11 should preferably be lower. However, when the front facet reflectivity is close to zero, laser oscillation does not occur in the semiconductor laser device 11, so that it becomes difficult to screen out defective semiconductor laser devices 11.

Therefore, in the semiconductor laser module 10 according to this embodiment, when a peak reflectivity of the diffraction grating 14a is R1 and a front facet reflectivity of the semiconductor laser device 11 is R2, the peak reflectivity R1 of the diffraction grating 14a and the front facet reflectivity R2 of the semiconductor laser device 11 are set so that the relation of 5%>R1>R2>0.05% is satisfied. It is also possible to further reduce the peak reflectivity R1 to less than 2%. Thus, with the semiconductor laser module 10 according to this embodiment, a high optical output can be obtained, and also defective semiconductor laser devices 11 can be easily screen out.

Further a tip form of a reflectivity spectrum of the diffraction grating 14a should preferably be controlled to be a rectangular shape. However, realizing this industrially in actual applications accompanies various difficulties, and is not easy. So the present inventors studied the way for approximating a tip form of a reflectivity spectrum of the diffraction grating 14a to a rectangular shape in actual industrial applications, and examined to what degree the tip form should be approximated to a rectangular shape for realization of oscillation with a plurality of longitudinal modes and the SBS suppression.

Reflectivity spectrums of diffraction gratings in the present embodiment as well as in a comparative example are shown in FIG. 7 respectively. As shown by a solid line in FIG. 7, in the diffraction grating 14a in this embodiment, the reflectivity spectrum is of the SinC shape in trigometric function. In contrast, the reflectivity spectrum of the conventional diffraction grating in the comparative example is of the Gaussian shape as indicated by a dashed line in FIG. 7. Control of the reflectivity spectrum as described above can be performed by adjusting a grating space in formation of the diffraction grating, a length of the diffraction grating, and modulation degree of refraction factor. A desired reflection spectrum can easily be realized also by using a chirped grating.

Relations between a reflectivity expressed as a percentage relative to the peak reflectivity and a reflectivity spectrum width corresponding thereto in the reflectivity spectrums of the diffraction gratings in this embodiment (SinC shape) and the comparative example (Gaussian shape) are shown in Table 1.

TABLE 1

| | |
|---|---|
| Embodiment | Comparative example |
| (sinC shape) | (Gaussian shape) |

| Percentage | Reflectivity | Percentage | Reflectivity |
|---|---|---|---|
| relative to | spectrum | relative to | spectrum |
| peak (%) | width (nm) | peak (%) | width (nm) |
| 100 | 0.00 | 100 | 0.00 |
| 95 | 0.29 | 95 | 0.24 |
| 90 | 0.41 | 90 | 0.35 |
| 85 | 0.50 | 85 | 0.46 |
| 80 | 0.59 | 80 | 0.53 |
| 75 | 0.67 | 75 | 0.59 |
| 70 | 0.73 | 70 | 0.67 |
| 65 | 0.80 | 65 | 0.76 |
| 60 | 0.86 | 60 | 0.84 |
| 55 | 0.94 | 55 | 0.92 |
| 50 | 1.00 | 50 | 1.00 |

In a tip form of the reflectivity spectrum, the SinC shape in this embodiment is closer to a rectangular shape than the Gaussian shape in the comparative example, so that a reflectivity spectrum width at high reflectivity is wider in the SinC shape than that in the Gaussian shape as shown in this table.

Both of the central wavelengths λc of output light beams obtained with the diffraction gratings in this embodiment and in the comparative example were almost identical, namely 1463 nm, and also both of the spectrum widths (at half maximum) Δλ were almost identical, namely about 3.5 nm. With the diffraction grating in the comparative example, however, a spectrum of an output light beam including only one longitudinal mode within −3 dB from the main peak optical amplitude as a reference was obtained, but with the diffraction grating 14a according to this embodiment, a spectrum of an output light beam including 2 to 3 longitudinal modes within −3 dB from the main peak optical amplitude as a reference was obtained.

As shown in Table 1, it was confirmed that, by controlling a spectrum width of a laser beam reflected by the diffraction grating 14a so that a reflectivity spectrum width at the 95% reflectivity of the peak reflectivity is more than 26% of the reflectivity spectrum width at the 50% reflectivity of the peak reflectivity, an output light spectrum including a plurality of longitudinal modes within −3 dB from an optical amplitude of the main peak as a reference could be obtained in a prespecified wavelength band width including the main peak.

(Second Embodiment)

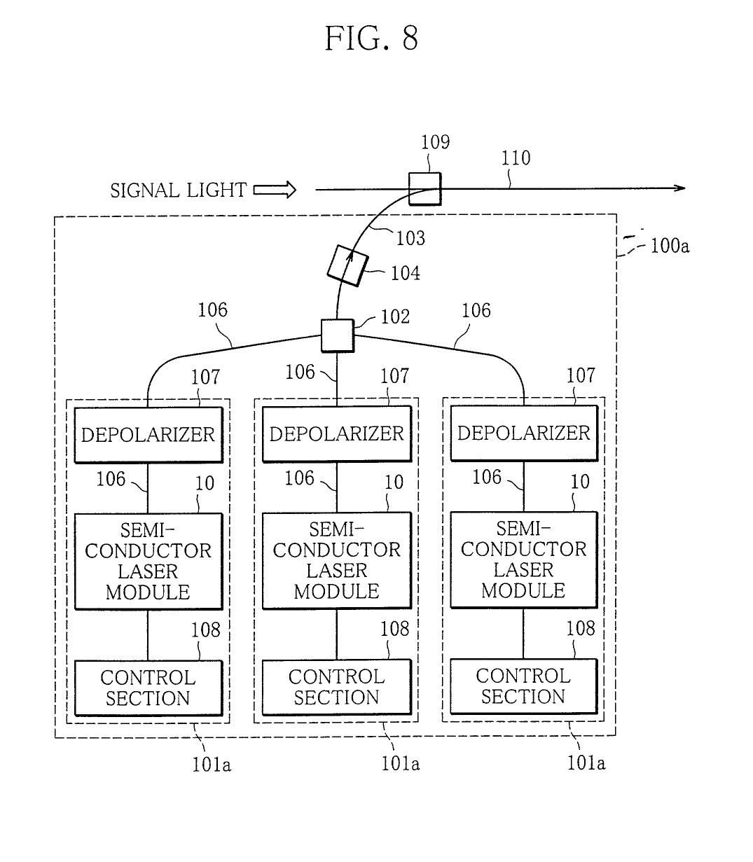

As shown in FIG. 8, a Raman amplifier 100a according to this embodiment is an optical amplifier based on the front excitation system comprising a plurality of laser units 101a emitting light beams with different wavelengths respectively, a WDM coupler 102 subjecting laser beams emitted from these laser units 101a to wavelength synthesis, an optical fiber 103 for transmitting the light beams having been subjected to wavelength synthesis with this WDM coupler 102, and an optical isolator 104 not dependent on polarization provided on the way of this optical fiber 103.

Each of the laser units 101a comprises a semiconductor laser module 10 according to the first embodiment, an optical fiber 106 for transmitting a laser beams emitted from this semiconductor laser module 10, a depolarizer 107 provided on the way of this optical fiber 106, and a control section 108 for controlling the semiconductor laser module 10.

The optical isolator 104 allows passage of a laser beam emitted from the semiconductor laser module 10, and at the same time cuts a light beam returning to the semiconductor laser module 10.

The depolarizer 107 is, for instance, a PMF inserted into a section on the way of the optical fiber 106, and the axis is inclined by 45 degrees against a polarization plane of a laser beam emitted from the semiconductor laser module 10. With this configuration, the DOP of a laser beam emitted from the semiconductor laser module 10 is reduced and the laser beam is depolarized.

The control section 108 is used for controlling operations of the semiconductor laser device in the semiconductor laser module 10, for instance, for controlling an injection current or a temperature of a Peltier module. Under the control by the control section 108, laser beams having different wavelengths respectively can be emitted from the laser units 101a.

Next, operations of the Raman amplifier 101a shown in FIG. 8 are described below.

In the Raman amplifier 100a shown in FIG. 8, a laser beam emitted from the semiconductor laser module 10 in each of the plurality of laser units 101a is subjected to processing for reducing the DOP by the depolarizer 107. And then, the depolarized laser beams are emitted from the depolarizers 107 in the plurality of laser units 101a as laser beams having different wavelengths respectively.

The laser beams having different wavelengths respectively are subjected to wavelength synthesis by the WDM coupler 102. The wavelength-synthesized laser beam is introduced as an excited light beam via the optical isolator 104 and WDM coupler 109 provided on the way of the optical fiber 103 into the optical fiber 110 for transmission of a signal light beam. Then the signal light beam in the optical fiber 110 is transmitted being amplified because of the Raman effect by the laser beam introduced as an excited light beam.

As described above, in the Raman amplifier 100a according to this embodiment, the laser units 101a incorporating the semiconductor laser modules 10 according to the first embodiment are used, so that a high Raman gain can be obtained and at the same time occurrence of the SBS in the optical fiber 110 can be suppressed. Also the length of the PMF's used as the depolarizers 107 for reduction of the DOP may be small, so that size reduction of the laser units 101a and also size reduction of the Raman amplifier 100a can be achieved.

(Third Embodiment)

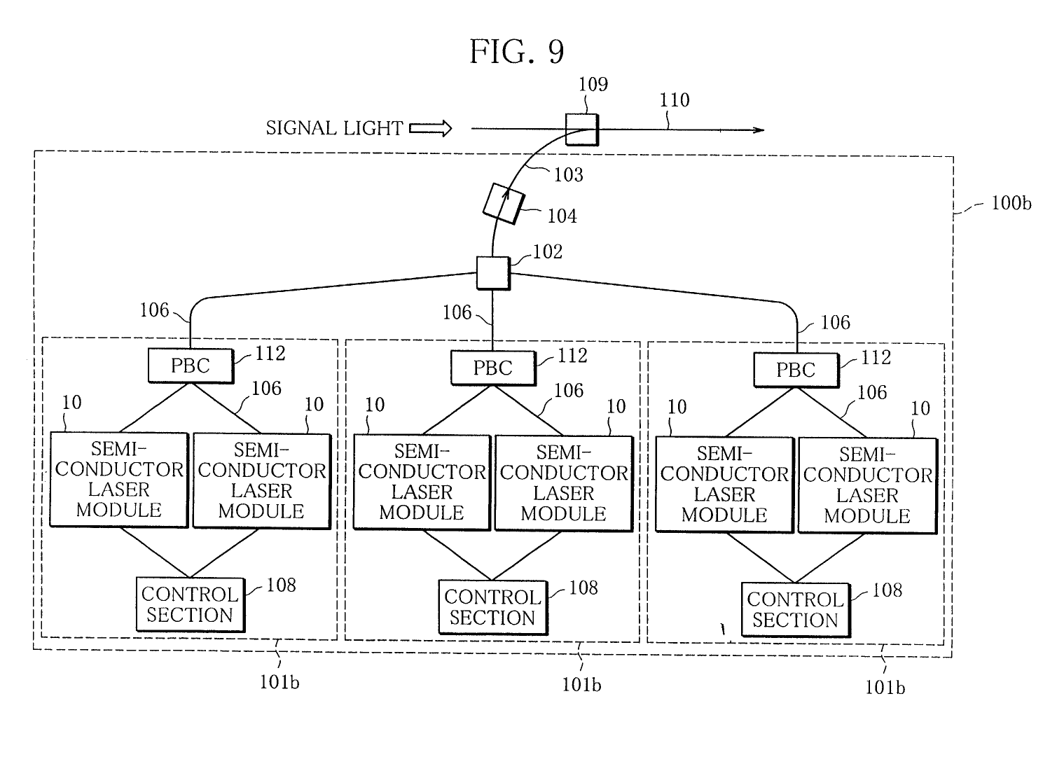

As shown in FIG. 9, a Raman amplifier 100b according to this embodiment is an optical amplifier based on the front excitation system comprising a plurality of laser units 101b emitting light beams having different wavelengths respectively, a WDM coupler 102 subjecting laser beams emitted from these laser units 101b to wavelength synthesis, an optical fiber 103 for transmitting the wavelength-synthesized light beam from this WDM coupler 102, and an optical isolator 104 not dependent on depolarization provided on the way of this optical fiber 103.

Each of the laser unit 101b comprises two semiconductor laser modules 10 according to the first embodiment, an optical fiber 106 for transmission of laser beams emitted from these semiconductor laser modules 10, a PBC (Polarization Beam Combiner) 112 provided on the way of this optical fiber 106, and a control section 108 for controlling the semiconductor laser modules 10.

The PBC 112 subjects the laser beams emitted from the semiconductor laser modules 10 to depolarization and wavelength synthesis.

Next, operations of the Raman amplifier 100 shown in FIG. 9 are described below.

In the Raman amplifier 100b shown in FIG. 9, laser beams emitted from the two semiconductor laser modules 10 in each of the laser units 101b are subjected by the PBC 112 to wavelength synthesis with same wavelength and different depolarization plane for reducing the DOP. And then, the depolarized laser beams are emitted from the PBC's 112 in the plurality of laser units 101b as laser beams having different wavelengths respectively.

The laser beams having different wavelengths respectively are subjected to wavelength synthesis by the WDM coupler 102. The wavelength-synthesized laser beam is introduced as an excited light beam via the optical isolator 104 and the WDM coupler 109 provided on the way of the optical fiber 103 into the optical fiber 110 for transmission of a signal light beam. The signal light beam in the optical fiber 110 is transmitted being amplified because of the Raman effect by the laser beam introduced as an excited light beam.

The Raman amplifier 100b according to this embodiment uses the laser units 101b incorporating the semiconductor laser modules 10 according to the first embodiment therein as described above, so that a high Raman gain can be obtained and also occurrence of the SBS in the optical fiber 110 can be suppressed.

The present invention is not limited to the first to third embodiments described above, and various types of variants are possible within the scope of this invention.

For instance, although description of the first embodiment above assumes the semiconductor laser module 10 having a resonance section functioning as an external resonator using the diffraction grating 14a comprising FBG as a wavelength selection means, a resonance section used in a semiconductor laser module according to the present invention is not limited to this type. For instance, a DFB laser incorporating a diffraction grating in an active layer of a semiconductor laser device or a laser with a diffraction grating monolithically incorporated on an emission surface of the semiconductor laser device.

Although descriptions of the second and third embodiments assume the Raman amplifiers 100a, 100b each based on the front excitation system in which the present invention can advantageously be applied, the Raman amplifier based on the present invention is not limited to that based on the front excitation system. The present invention can be applied to Raman amplifiers based on, for instance, the rear excitation system or the bi-directional excitation system.

As described above, in the semiconductor laser module according to the present invention, based on the presumption that the semiconductor laser module performs multimode oscillation, arranging is performed so that a plurality of longitudinal modes including a main peak are included within −3 dB from an optical amplitude at the main peak as a reference in a prespecified band wavelength including the main peak of a spectrum of a laser beam emitted from a resonance section.

As a result, with the semiconductor laser module according to the present invention, it is possible to reduce an optical amplitude of a main peak keeping a high optical amplitude as a whole. Therefore, occurrence of the SBS phenomenon in an optical fiber can efficiently be prevented while maintaining a high optical power output.

With the semiconductor laser module according to the present invention, when a plurality of longitudinal modes for high output laser beams having different wavelengths respectively are present, coherency of the laser beam becomes lower, so that reduction of DOP can efficiently be performed. Further as a narrow wavelength band width can be maintained with a wavelength selection means, a high PIB can be achieved.

With the laser unit according to the present invention, the semiconductor laser module capable of realizing a high optical power output and a high PIB and at the same time capable of efficient suppression of SBS and reduction of DOP is used therein, so that the laser unit can advantageously be applied to an excited light beam source for a Raman amplifier.

In addition, with the Raman amplifier according to the present invention, a semiconductor laser module or a laser unit capable of realizing a high optical power output and a high PIB and at the same time capable of efficient suppression of SBS and reduction of DOP is used therein, so that a high Raman gain can be obtained.

What is claimed is:

1. A semiconductor laser module comprising:
a semiconductor laser device;
a wavelength selection means for deciding an oscillation wavelength of said semiconductor laser device; and
an optical fiber for transmitting a laser beam emitted from a resonance section having said semiconductor laser device and said wavelength selection means, wherein said semiconductor laser device oscillates in the multimode, and a plurality of longitudinal modes are included within −3 dB from an optical amplitude of a main peak in a spectrum of the laser beam emitted from said resonance section.

2. The semiconductor laser module of claim 1, wherein a number of said longitudinal modes is 4 or more.

3. The semiconductor laser module of claim 1, wherein the optical amplitude of said main peak is less than a threshold value for generation of SBS.

4. The semiconductor laser module of claim 1, wherein a spectrum width of a laser beam emitted from said resonance section is a prespecified value in the range from 0.3 to 3 nm.

5. The semiconductor laser module of claim 1, wherein a space between the longitudinal modes of a laser beam emitted from said resonance section is larger than a SBS contribution band width.

6. The semiconductor laser module of claim 1, wherein said resonance section is of an external resonator structure.

7. The semiconductor laser module of claim 1, wherein said wavelength selection means is a diffraction grating having a peak reflectivity at a prespecified wavelength.

8. The semiconductor laser module of claim 7, wherein a peak reflectivity R1 of light beam in said diffraction grating and a reflectivity R2 of light beam at a front facet of said semiconductor laser device satisfy the following relation:
5%>R1>R2>0.05%

9. The semiconductor laser module of claim 7, wherein, in the reflectivity spectrum of said diffraction grating, a wavelength band width for a reflectivity which is equal to 95% of the peak reflectivity is 0.26 times or more of a wavelength band width for a reflectivity which is equal to 50% of the peak reflectivity.

10. The semiconductor laser module of claim 7, wherein a reflectivity spectrum of said diffraction grating is substantially rectangular.

11. The semiconductor laser module of claim 7, wherein a reflectivity spectrum of said diffraction grating is of a SinC shape.

12. The semiconductor laser module of claim 7, wherein a reflection spectrum width of said diffraction grating has a prespecified value in the range from 1 to 5 nm.

13. The semiconductor laser module of claim 1, wherein said semiconductor laser module is used as an excited light beam source module for a Raman amplifier.

14. A laser unit comprising:
a plurality of said semiconductor laser modules as described in claim 1; and
a plurality of depolarizers which reduce DOP of laser beams emitted from said plurality of semiconductor laser modules respectively.

15. A laser unit comprising:
a plurality of said semiconductor laser modules as described in claim 1; and
a plurality of polarization synthesis means for subjecting laser beams emitted from said plurality of semiconductor laser modules to polarization synthesis respectively.

16. A Raman amplifier comprising:
said semiconductor laser module unit of claim 1 or said laser unit of claim 14 or claim 15; and
a control means for controlling said semiconductor laser module or said laser unit.
